(19) United States
(12) Patent Application Publication
(10) Pub. No.: US 2016/0188801 A1
(43) Pub. Date: Jun. 30, 2016

(54) SECURE STORAGE AND TRANSMISSION OF MEDICAL INFORMATION

(71) Applicant: AirWatch LLC, Atlanta, GA (US)

(72) Inventors: Kar Fai Tse, Peachtree Corners, GA (US); Chaoting Xuan, Duluth, GA (US); Chen Lu, Sandy Springs, GA (US)

(21) Appl. No.: 14/584,097

(22) Filed: Dec. 29, 2014

(51) Int. Cl. G06F 19/00; G06F 21/31; H04L 29/06; H04L 29/08; G06F 21/62

(52) U.S. Cl. CPC G06F 19/322; H04L 67/12; G06F 21/6245; G06F 21/6263; H04L 63/06; G06F 21/31; H04L 63/083; H04L 63/0428

(57) ABSTRACT

Disclosed are various embodiments for securely storing and transmitting medical- or health-related information. According to various embodiments described herein, a computing device may enroll or register a client device or a peripheral device associated with the client device in response to the client device or the peripheral device complying with at least one compliance rule. Health information received from the client device or the peripheral device is accessed in response a request received from a requesting service for the health information, wherein the health information as received is encrypted according to a cryptographic key. A determination is made whether consent to send the health information to the requesting service has been provided by a user of the client device. If consent has been provided, the health information received from the client device or the peripheral device is sent to the requesting service.

### BACKGROUND

Complying with healthcare-related regulations remains problematic in various countries given the emergence of mobile computing technology and health-related peripheral devices. For example, the Health Insurance Portability and Accountability Act (HIPPA) in the United States requires patient consent before medical- or healthcare-related information is disseminated electronically. With the rise of biometric sensors that integrate with mobile devices as well as the rise of outsourcing of medical services, satisfying health-related regulations remains difficult.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing illustrating a peripheral device and a client device configured to communicate health information over a network according to various embodiments of the present disclosure.

FIG. 2 is a drawing of a networked environment employing the peripheral device and the client device of FIG. 1 according to various embodiments of the present disclosure.

FIG. 3 illustrates the client device of FIG. 1 obtaining consent from a user of the client device according to various embodiments of the present disclosure.

FIG. 4 illustrates the client device of FIG. 1 obtaining consent from a user of the client device according to various embodiments of the present disclosure.

FIGS. 5A-B illustrate a process whereby the client device of FIG. 1 obtains health information from one or more peripheral devices according to various embodiments of the present disclosure.

FIG. 6 illustrates a cryptographic process that may be performed to encrypt and/or decrypt the health information using one or more keys according to various embodiments of the present disclosure.

FIG. 7 is a flowchart illustrating one example of functionality implemented as portions of a device management application executed in a computing environment in the networked environment of FIG. 2 according to various embodiments of the present disclosure.

FIG. 8 is a flowchart illustrating one example of functionality implemented as portions of a client application executed in a client device in the networked environment of FIG. 2 according to various embodiments of the present disclosure.

FIG. 9 is a schematic block diagram that provides one example illustration of a computing environment employed in the networked environment of FIG. 2 according to various embodiments of the present disclosure.

### DETAILED DESCRIPTION

The present disclosure relates to securely storing and transmitting medical- or health-related information. As discussed above, complying with healthcare-related regulations remains problematic in various countries given the emergence of mobile computing technology and health-related peripheral devices. For example, the Health Insurance Portability and Accountability Act (HIPPA) in the United States requires patient consent before medical- or healthcare-related information is disseminated electronically. With the rise of biometric sensors that integrate with mobile devices as well as the rise of outsourcing of medical services, satisfying health-related regulations remains difficult.

Various peripheral devices are configured to interact with mobile devices, for example, by communicating health-related information collected by the peripheral devices to a particular mobile device using BLUETOOTH®, ZIGBEE®, near field communication (NFC), wireless fidelity (Wi-Fi), infrared, or similar technology. For example, peripheral devices may include sensors that measure blood pressure, heart rate, physical activity, sleep patterns, body movement, calories burned in a given time frame, blood sugar, cholesterol levels, etc. Such information may be considered sensitive and dissemination of the information may not be desired under various circumstances. Further, the dissemination of such information may also be subject to regulatory guidelines.

Similarly, users of mobile devices are capable of manually recording and/or storing health-related information in their mobile device such as nutritional information (e.g., items of food and calories consumed in a day), information related to medication regiments, etc. This information may also be considered sensitive and dissemination of such information may be undesirable to the users or subject to regulatory guidelines.

The present disclosure is related to securely storing and transmitting medical- or health-related information. In various embodiments, a client application executing on a client device may determine whether the client device complies with one or more compliance rules to determine whether any security vulnerabilities exist on the client device and to establish storage compliance rules and transmission compliance rules. Assuming the client device complies with the one or more compliance rules, health information collected by the client device may be encrypted using at least one cryptographic key.

A computing environment (e.g., one or more servers) in communication with the client device may receive requests for health information associated with a variety of electronic services, such as health-related services associated with hospitals, doctor's offices, health specialists, personal trainers, other medical practitioners, insurance companies, health information aggregators, etc. The computing environment may request the health information from the client device by causing a notification to be displayed by the client device that prompts the user of the client device to indicate whether health information stored on the client device or in the computing environment should be transmitted to the computing environment and/or the requesting service. Assuming the user indicates that the health information should be transmitted to the requesting service, the transmission of the encrypted health information to the computing environment and/or the requesting service may be initiated.

Further, various encryption methodologies may be employed to ensure protection of sensitive medical- or health-related information. According to various embodiments, encryption of health information may comprise encrypting the health information using a password or a personal identification number (PIN) corresponding to a user (e.g., determined based on a PIN or a password provided by the user) and/or a password or a PIN corresponding to a requesting service (e.g., determined based on a PIN or a password provided by the requesting service). The encryption of the health information may be performed by the client device or the computing environment, as will be described in greater detail below.

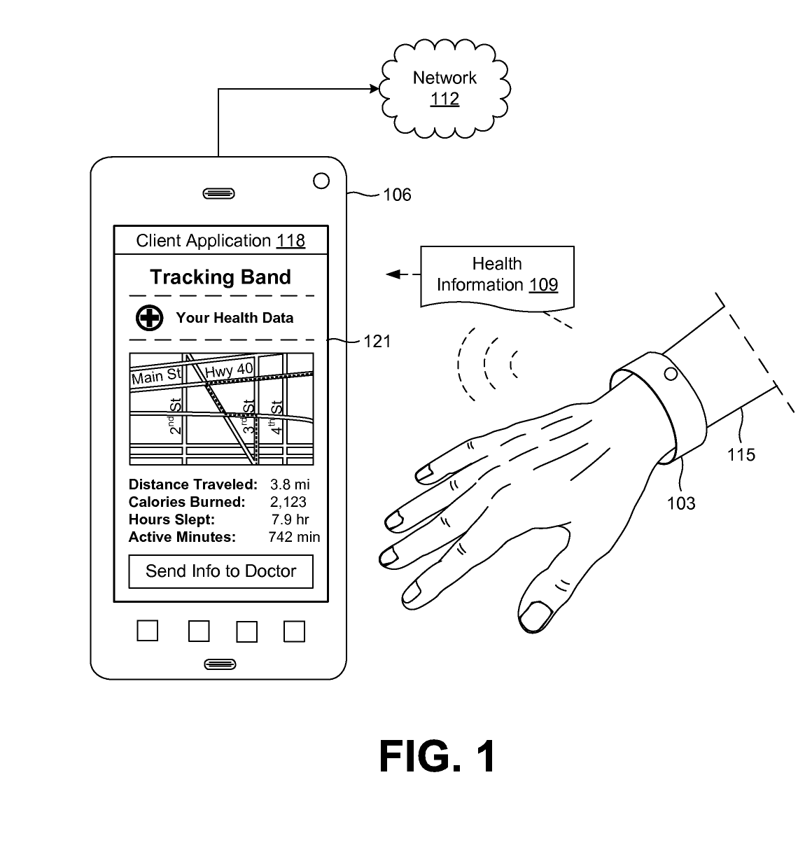

Beginning with FIG. 1, shown is a peripheral device 103 and a client device 106 configured to communicate health information 109 over a network 112 according to various embodiments of the present disclosure. In the example of FIG. 1, the peripheral device 103 includes an electronic and/or mechanical device that may be worn by a person 115. As may be appreciated, the peripheral device 103 may include one or more biometric sensors, gyroscopes, or components capable of measuring health information 109 (not shown). For example, biometric sensors may be capable of measuring steps taken, routes traveled, heart rate, physical activity, calories burned, etc., for the person 115 at a particular point in time (or even for a duration of time).

Using BLUETOOTH®, ZIGBEE®, near field communication (NFC), wireless fidelity (Wi-Fi), infrared, or similar technology, the peripheral device 103 may communicate the health information 109 measured via the one or more sensors to the client device 106. The client device 106, via a client application 118 executing on the client device 106, may store the health information 109 locally on the client device 106 and/or communicate the health information over the network 112 as will be described in greater detail below.

The client device 106 may comprise, for example, a processor-based system such as a computer system. Such a computer system may be embodied in the form of a desktop computer, laptop computer, personal digital assistant, cellular telephone, set-top-box, music player, wearable computing device (e.g., smart watch or GOOGLE GLASS™), web pad, tablet computer system, game console, electronic book reader, or other device with like capability. In the example of FIG. 1, the client device 106 is shown as a smartphone. The client application 118 executable on the client device 106 may facilitate enrolling the client device 106 in a management service, obtaining health information 109 from one or more peripheral devices 103, encrypting the health information 109 for local storage, and transmitting the health information 109 to another system via the network 112.

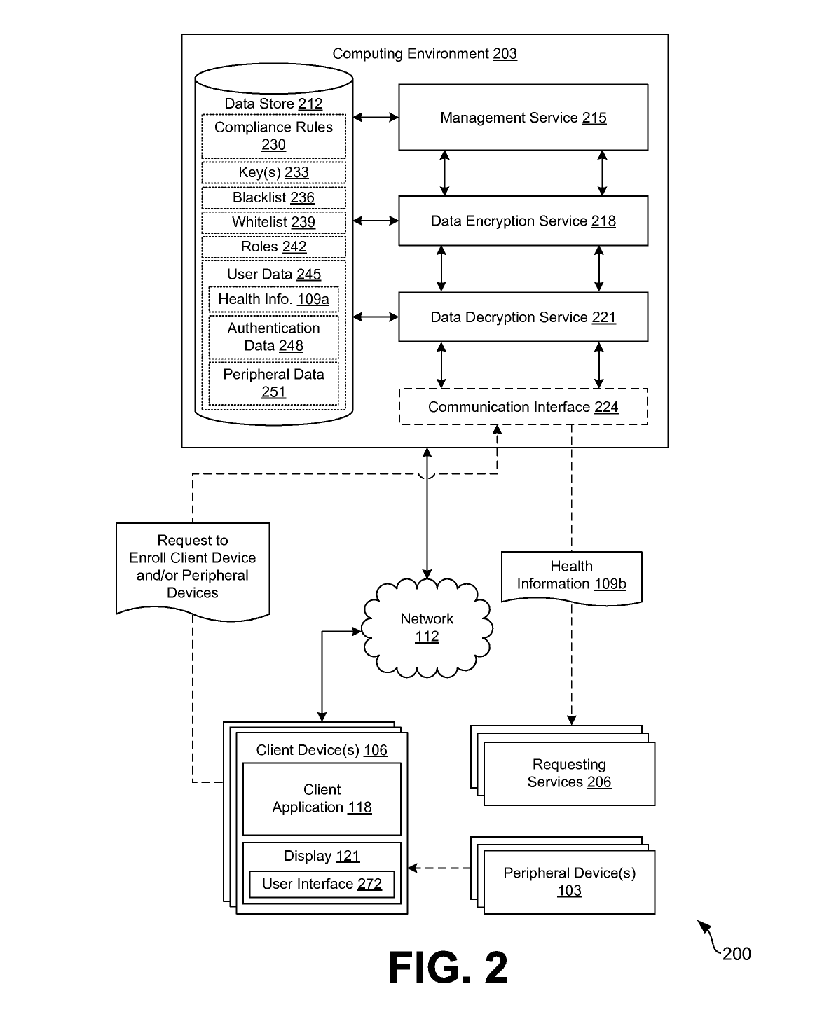

With reference to FIG. 2, shown is a networked environment 200 according to various embodiments. The networked environment 200 includes a computing environment 203, the peripheral device 103, the client device 106, and a requesting service 206 which are in data communication with each other over the network 112. The network 112 includes, for example, the Internet, intranets, extranets, wide area networks (WANs), local area networks (LANs), wired networks, wireless networks, or other suitable networks, etc., or any combination of two or more such networks. For example, such networks may comprise satellite networks, cable networks, Ethernet networks, and other types of networks.

The computing environment 203 may comprise, for example, a server computer or any other system providing computing capability. Alternatively, the computing environment 203 may employ a plurality of computing devices that may be arranged, for example, in one or more server banks or computer banks or other arrangements. Such computing devices may be located in a single installation or may be distributed among many different geographical locations. For example, the computing environment 203 may include a plurality of computing devices that together may comprise a hosted computing resource, a grid computing resource, a virtualized computing environment and/or any other distributed computing arrangement. In some cases, the computing environment 203 may correspond to an elastic computing resource where the allotted capacity of processing, network, storage, or other computing-related resources may vary over time.

Various applications and/or other functionality may be executed in the computing environment 203 according to various embodiments. Also, various data is stored in a data store 212 that is accessible to the computing environment 203. The data store 212 may be representative of a plurality of data stores 212 as can be appreciated. The data stored in the data store 212, for example, is associated with the operation of the various applications and/or functional entities described below.

The components executed on the computing environment 203, for example, include a management service 215, a data encryption service 218, a data decryption service 221, and other applications, services, processes, systems, engines, or functionality not discussed in detail herein. The computing environment 203 may further comprise a communication interface 224 which may comprise a combination of circuitry, applications, services, processes, systems, engines, or functionality not discussed in detail herein.

The management service 215 is executed to manage and/or oversee the collection and storage of the health information 109 by the client device and/or the computing environment 203. Further, the management service 215 is executed to manage and oversee the transmission of health information 109 over the network 112. For example, the client device 106 may obtain health information 109 manually from a user of the client device 106 or may obtain health information 109 through one or more peripheral devices 103. The management service 215 may ensure that the client device 106 stores the health information 109 such that the storage complies with one or more compliance rules 230. Similarly, the management service 215 may facilitate the transmission of the health information 109 to one or more requesting services 206 such that the transmission of the health information 109 complies with one or more compliance rules 230.

The data encryption service 218 is executed to encrypt data, such as health information 109, at the direction of the management service 215. To encrypt data, the data encryption service 218 may employ one or more cryptographic keys (hereinafter referred to as “keys”). The keys specify a particular transformation of data, such as health information 109 obtained in plaintext or in a predefined data format, into ciphertext.

Conversely, the data decryption service 221 is executed to decrypt data, such as health information 109, at the direction of the management service 215. To decrypt data, the data decryption service 221 may employ keys that specify a particular transformation of data, such as health information 109 received in ciphertext, to plaintext or another data format. According to various embodiments described herein, the keys may include symmetric cryptographic keys that use a same cryptographic key for both encryption of plaintext and decryption of ciphertext. A symmetric key may be generated by the management service 215 specifically for a user, a client device 106, and/or or a requesting service 206, such that the key is unique to the user, the client device 106, and/or the requesting service 206. For example, the key 233 generated by the management service 215 may be generated using a password, a PIN, or other information provided by a user of the client device 106 during enrollment of the client device 106 into the management service 215.

The communication interface 224 is executed to facilitate communication between the computing environment 203 and the client devices 106 or between the computing environment 203 and the requesting services 206 over the network 112. To this end, the communication interface 224 may comprise an application programming interface (API) embodied in software that facilitates programmatic service calls (e.g., API calls) made by the client devices 106 to communicate with the management service 215, the data encryption service 218, the data decryption service 221, and/or other services or applications not described herein.

The data stored in the data store 212 includes, for example, compliance rules 230, keys 233, a blacklist 236, a whitelist 239, roles 242, and/or user data 245. Compliance rules 230 may comprise particular configurations or particular constraints that must be satisfied prior to storing and/or transmitting health information 109 by the client device 106 or by the computing environment 203. In various embodiments, compliance rules 230 may include restraints on various types of peripheral devices 103 and may be defined by the requesting service 206. For example, a physician may desire that his or her patient only use a particular brand or type of a heart rate monitor. Compliance rules 230 may require a user to provide consent prior to sending particular health information 109 and/or a particular type of health information 109. Further, compliance rules 230 may include constraints on applications, services, functions, peripheral devices 103, such as those included in the blacklist 236 (i.e., not permitted) or the whitelist 239 (i.e., permitted). In some embodiments, the compliance rules 230 include regulatory or statutory constraints that may be updated by the management service 215 or another service. To this effect, the compliance rules 230 may be used in determining whether a client device 106 and/or a peripheral device 103 associated with the client device 106 comply with the regulatory or statutory constraints.

The keys 233 include cryptographic keys that specify a particular transformation of data, such as health information 109, into ciphertext. Traditionally, ciphertext is unable to be discerned without performing decryption. The keys 233 include symmetric keys generated by the management service 215 specifically for a user, a client device, and/or or a requesting service, such that the key is unique to the user, the client device, and/or the requesting service. For example, the key generated by the management service 215 may be generated using a password, a PIN, or other information provided by a user of the client device 106 during enrollment.

The blacklist 236 includes a list of disallowable functions, applications, peripheral devices 103, or other information that is not permitted as it may run afoul of a regulatory requirement and/or may pose a vulnerability to security of the health information 109. Conversely, the whitelist 239 includes a list of permitted functions, applications, peripheral devices 103, or other information that is permitted as it complies with a regulatory requirement and/or does not pose a vulnerability to security of the health information 109. In various embodiments, the whitelist 239 or the blacklist 236 may include a permitted (or not-permitted) type of device based on, for example, a manufacturer of the device, an operating system (e.g., Android® or iOS®) of the device, a version of the operating system, etc.

The roles 242 include a designation for a particular requesting service 206. For example, if a requesting service 206 includes an electronic service operated by an insurance company, the role 242 for the requesting service 206 may be designated “insurance company.” In various embodiments, the user of the client device 106 may set the role 242 for his or her physician such that the requesting service 206 associated with the physician has access to all health information 109 (e.g., nutritional information, heart rate data, physical activity, and blood sugar measurements). Similarly, the same user of the client device 106 may set a different role 242 for his or her personal trainer such that the personal trainer only has access to a subset of the health information 109 (e.g., nutritional information and physical activity).

To this end, each requesting service 206 may be assigned a role 242 that defines a level of access to the health information 109 for a particular user and/or client device 106. Although in various embodiments, the role 242 for a particular requesting service 206 may be set by the management service 215 during a registration and/or enrollment process (e.g., based at least in part on a type of requesting service 206), the role 242 may be defined and/or modified by the user associated with the health information 109 being requested.

User data 245 includes data associated with one or more users of the client devices 106 and/or the peripheral devices 103. The user data 245 may include health information 109a stored in association with a particular user of a particular client device 106. Further, the user data 245 may include authentication data 248 that may include data associated with a username, a password, a numeric pin, and/or other information that may be used to authenticate a user of the client device 106 and/or the peripheral device 103. The user data 245 further includes peripheral data 251. Peripheral data 251 may comprise information associated with one or more peripheral devices 103, such as a make, model, year, manufacturer, or other information that may facilitate interpreting health information 109 measured by a given peripheral device 103.

The client device 106 is representative of a plurality of client devices 106 that may be coupled to the network 112. As discussed above, the client device 106 may comprise, for example, a processor-based system such as a computer system. Such a computer system may be embodied in the form of a desktop computer, a laptop computer, a personal digital assistant, a cellular telephone, a smartphone, a set-top-box, a music player, a web pad, a tablet computer system, a game console, an electronic book reader, or any other device with like capability. The client device 106 may include a display 121. The client device 106 may be configured to execute various applications such as the client application 118 and/or other applications. The client application 118 may be executed in a client device 106, for example, to access network content served up by the computing environment 203 and/or other servers, thereby rendering a user interface 272 on the display 121. To this end, the client application 118 may comprise, for example, a browser, a dedicated application, etc., and the user interface 272 may comprise a network page, an application screen, etc. The client device 106 may be configured to execute applications beyond the client application 118 such as, for example, email applications, social networking applications, word processors, spreadsheets, and/or other applications.

The peripheral device 103 is representative of one or more peripheral devices 103 that may be coupled to the client device 106 and/or the network 112. In various embodiments, the peripheral device 103 may comprise, for example, a processor-based system. The peripheral device 103 may include one or more sensors (not shown) capable of obtaining health information from a person 115 (FIG. 1).

Next, a general description of the operation of the various components of the networked environment 200 is provided. To begin, one or more requesting services 206 (e.g., doctor's offices, hospitals, insurance companies, health information aggregators, etc.) can be enrolled and/or registered with the management service 215 such that the requesting service 206 is able to request health information 109 for a particular user or for a particular client device 106. Enrollment and/or registration of a particular one of the requesting services 206 may include vetting and scrutinizing the particular requesting service 206 by an administrator of the management service 215 such that unauthorized access to sensitive information is not obtained. Each of the requesting services 206 may be associated with compliance rules 230 that may be sent for a client device 106 to determine, for example, whether the client device 106 complies with one or more of the compliance rules 230. Accordingly, in various embodiments, the management service 215 may determine compliance of devices (e.g., client devices 106 or peripheral devices 103) associated with a requesting service 206.

To this end, each requesting service 206 may be assigned a role 242 by the management service 215 that automatically defines a level of access to the health information 109 for a particular user and/or client device 106. The role 242 may be determined based on an operator of the requesting service 206. For example, if the operator of the requesting service 206 is a physical trainer, the role 242 may be assigned such that it automatically obtains access to nutritional information and/or physical activity associated with the user of the client device 106 while denying access to more sensitive health information 109. Although in various embodiments, the role 242 for a particular requesting service 206 may be automatically determined by the management service 215 during a registration and/or enrollment process (e.g., based at least in part on a type of requesting service 206), the role 242 may be defined and/or modified by the user associated with the health information 109 being requested.

For example, the user of the client device 106 may set the role 242 for his or her physician such that the requesting service 206 associated with the physician has access to all general health information 109 (e.g., nutritional information, heart rate data, physical activity, and blood sugar measurements). Similarly, the same user of the client device 106 may set a different role 242 for his or her personal trainer such that the personal trainer only has access to a subset of the health information 109 (e.g., nutritional information and physical activity).

In various embodiments, when a user of a client device 106 enrolls a particular type of peripheral device 103, the health information 109 obtained by the peripheral device 103 is automatically made accessible to a particular requesting service 206 based at least in part on the role 242 assigned to the particular requesting service 206. For example, assuming the user of the client device 106 enrolled a blood sugar monitor with the management service 215, any health information 109 measured by the blood sugar monitor will automatically be made accessible to the requesting service 206 associated with the user's physician while the user's personal trainer is denied access.

The management service 215 may also receive a request to enroll and/or register the client device 106. Enrolling and/or registering the client device 106 may involve downloading a particular client application 118 and registering the client device 106 via one or more user interfaces 272 rendered in the display 121 of the client device 106. In various embodiments, one or more peripheral devices 103 associated with the client device 106 may also be registered and/or enrolled with the management service 215. In various embodiments, the user may establish a mechanism to provide consent to the management service 215 or to requesting services, such as healthcare providers or heath information aggregators. For example, the user may create a PIN, password, gesture, device pairing, etc., that, when detected, provides consent for the transmission of health information 109 to a requesting service. In various embodiments, the mechanism to provide consent is generated by the management service 215 at time a of enrollment without input provided by a user.

Subsequently, the management service 215 verifies that the client device 106 complies with one or more compliance rules 230, for example, to ensure that the client device 106 does not have any security vulnerabilities that may compromise storage of sensitive information, including health information 109. Similarly, verifying that the client device 106 complies with one or more compliance rules 230 may be beneficial in ensuring that the user of the client device 106 is not using faulty, dangerous, and/or unapproved peripheral devices 103. Some security vulnerabilities may include unauthorized applications, malware, viruses, worms, key loggers, bots, or other malicious code or software, such as those defined in the blacklist 236. Unauthorized applications may include applications that are not configured to enforce particular configurations and/or compliance rules 230 that reflect the security policies of a regulation, an enterprise, a healthcare provider, etc.

Conversely, examples of applications that may be considered authorized include applications that provide the ability to enforce particular configurations and/or particular compliance rules 230, such as those applications defined in the whitelist 239. For example, in the context of a statute or a regulatory requirement, authorized applications may include applications modified and/or configured to enforce particular configurations and/or compliance rules 230 that reflect the security policies of the statute or the regulatory requirement.

Consequently, compliance rules 230 may comprise particular configurations or particular constraints that must be satisfied prior to storing and/or transmitting health information 109 by the client device 106 or by the computing environment 203. In various embodiments, compliance rules 230 may include restraints on various types of peripheral devices 103 and may be defined by the requesting service 206. For example, a physician may desire that his or her patient only use a particular brand or model of a heart rate monitor. Similarly, the restraints may require that a peripheral device 103 has been calibrated within a threshold duration, has sufficient battery life, etc. Further, compliance rules 230 may include requiring a user to provide consent one or more times prior to sending particular health information 109 and/or a particular type of health information 109.

In some embodiments, the management service 215 may instruct the client device 106 to present a notification to the user of the client device 106. For instance, the client device 106 may present a notification to the user of the client device 106 that specifies that the client device 106 is not in a state of compliance with a particular compliance rule 230 (i.e., such that the user may make alterations to the client device 106 to place the client device 106 in a state of compliance with the compliance rule 230). The client device 106 may also present a notification that specifies that if the client device 106 is not placed in a state of compliance with the particular compliance rule 230 (e.g., by enabling, disabling, and/or modifying the client device 106) before a threshold duration expires, that a particular remedial action may be taken on the client device 106 (e.g., erasing data from the client device 106, preventing the client device 106 from accessing particular files or resources, and/or locking particular functionality of the client device 106).

Assuming the client device 106 complies with one or more compliance rules 230, a key 233 may be generated and/or sent to the client device 106. In various embodiments, the key 233 may be a user-specific or device-specific key 233 generated based at least in part on a password, a pin, or other authentication data 248 provided by the user. In some embodiments, the key 233 may be specific to a combination of a user and a device. To this end, the user may use the password, the pin, or other information to unlock and gain access to particular data. For example, the user may provide a PIN to unlock and/or decipher the key 233. The key 233 provided by the management service 215 to the client device 106 may be stored locally on the client device 106 (e.g., in memory internal to the client device 106).

As discussed above, requests for health information 109 may be received from various requesting services 206. For example, a physician may desire to see recent blood sugar measurements for a particular patient. The physician, acting as a requesting service 206 through the management service 215, may request the blood sugar measurements from the client device 106 associated with the particular patient. In response to a request for health information 109, it is determined whether consent has already been provided for the type of information being requested (e.g., blood sugar measurements) and/or the requesting service 206 (e.g., the particular patient's physician). If consent from the user of the client device 106 has not been obtained, consent must be manually obtained from a user of the client device 106.

Obtaining consent from a user of the client device 106 may include, for example, causing a notification to be presented to the user of the client device 106 associated with the request for health information 109. In various embodiments, the notification may include the requesting service 206, the type of information being requested, the specific health information 109 being requested, etc. Accordingly, the user may be provided with sufficient information to provide informed consent in distributing his or her health information 109. Assuming consent to access the health information 109 has been provided in association with the request, the management service 215 may receive health information 109 from the client device 106 prior to the health information 109 being sent to the requesting service 206.

In various embodiments, the client device 106, through the client application 118, is configured to encrypt the health information 109 prior to storage on the client device 106. Encryption may include utilizing the key 233 (i.e., a cryptographic key) provided to the client device 106 that can be unique to the user of the client device 106. Accordingly, the health information 109 received by the management service 215 in the computing environment 203 may be encrypted. As the health information 109 is encrypted using the key 233 (e.g., unique to the user and/or the client device 106), it remains difficult or impossible for the health information 109 to be accessed by third parties.

Next, the health information 109 as encrypted is further encrypted with a password (also referred to as “wrapped” or “key wrapped”) by the management service 215 through the data encryption service 218 or a similar service. However, in various embodiments, encrypting the health information 109 includes decrypting the health information 109 prior to encryption by the computing environment 203. In some embodiments, the key 233 includes a double-encrypted key 233 with a provider-specific key. In these embodiments, the requesting service 206 would need two keys 233 to decipher the health information 109. After decrypting the health information 109, encryption of the health information 109 may be performed based on, for example, a key 233 and/or a password associated with the requesting service 206.

The health information 109 may be transmitted to the requesting service 206, for example, with the user-specific key 233 (or the user-specific key 233 associated with the health information 109 may be sent to the requesting service 206 at a different time). In some embodiments, the health information 109 and/or the key 233 may be sent in place of or in addition to transmission over the network 112 to provide additional security. For example, the key 233 may be communicated to a requesting service via email or simple messaging service (SMS). Using the user-specific key 233 and the service-specific key 233, the requesting service 206 is able to decrypt the health information 109 for authorized access. After the health information 109 has been encrypted, the health information 109b is sent or transmitted to the requesting service 206 for decryption by the requesting service 206.

In various embodiments of the present disclosure, consent may be required from a user of the client device 106 based on a detection of emergency services prior to disseminating sensitive information, such as the health information 109. For example, a user may be required to input a pin number or other identifier before the client device 106 transmits medical information from the client device 106 over a network 112. However, in various embodiments, consent may automatically be bypassed. For example, in various embodiments, a peripheral device, such as a blood or heart monitor, may perform measurements that indicate an emergency situation, such as a dangerous or fatal blood sugar level or an irregular heartbeat. If the measurements taken by the peripheral device meet or exceed a threshold indicating that an emergency situation is occurring or imminent, consent may not be required. As a result, the measurements taken by the peripheral devices (e.g., the health information 109) may be transmitted over the network 112 without user consent.

In various embodiments, the client device 106 may be configured to upload health information 109 to the management service 215 on a pre-configured frequency defined by the user, an administrator, or settings set forth by a peripheral device 103. As a result, in some embodiments, the management service 215 may be required to request consent from the user of the client device 106 for transmission of information (e.g., health information) to third-parties, such as healthcare providers or health data aggregators. In some embodiments, the management service 215 may provide requesting services (e.g., healthcare providers) with direct access to the client device 106 once consent is received from the client device 106. As a result, the health information 109 obtained by the client device 106 may be automatically communicated to the requesting service without having to communicate through the management service 215. To clarify, the health information 109 is not received by the management service 215 once consent is received.

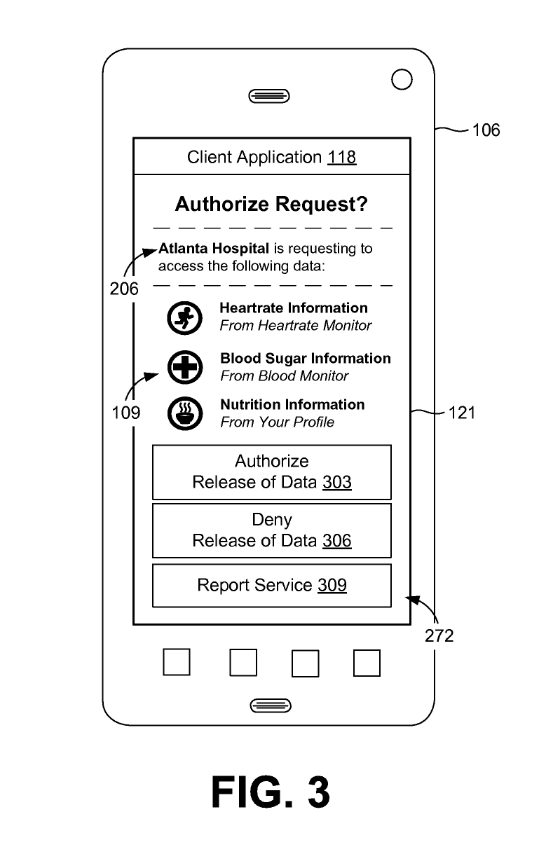

Referring next to FIG. 3, shown is an example of the client device 106 obtaining consent from a user of the client device 106 to transmit health information 109 (FIG. 1) to a requesting service 206 (FIG. 2) according to various embodiments of the present disclosure.

In the example of FIG. 3, the client application 118 causes a user interface 272 to be rendered on the display 121 of the client device 106. Specifically, in FIG. 3, the user interface 272 comprises information associated with the requesting service 206, such as “Atlanta Hospital.” Further, the user interface 272 includes information associated with the subset of health information 109 requested to be accessed (e.g., “Heart Rate Information,” “Blood Sugar Information,” and “Nutrition Information”).

By manipulating (e.g., pressing and releasing) component 303 in the user interface 272, the user may authorize the release of the subset of the health information 109. Alternatively, by manipulating component 306 in the user interface 272, the user may deny the release of the subset of the health information 109. In various circumstances, it is possible that a requesting service 206 may request information beyond its role 242 (FIG. 2). Accordingly, by manipulating component 309, the user of the client device 106 may report the requesting service 206 for trying to access information sensitive information and/or information beyond its role 242. The user may be notified of information requested by a requesting service 206 that is beyond the defined role 242 for the requesting service 206. For example, if a healthcare specialist wants all health information 109 for a user, a notification may be presented comprising the requesting service 206 and the information requested such that a user may easily discern whether to authorize a dissemination of the requested information. As may be appreciated, if negative feedback obtained in the form of reports made by various users exceeds a threshold, the requesting service 206 may be added to the blacklist 236 (FIG. 2).

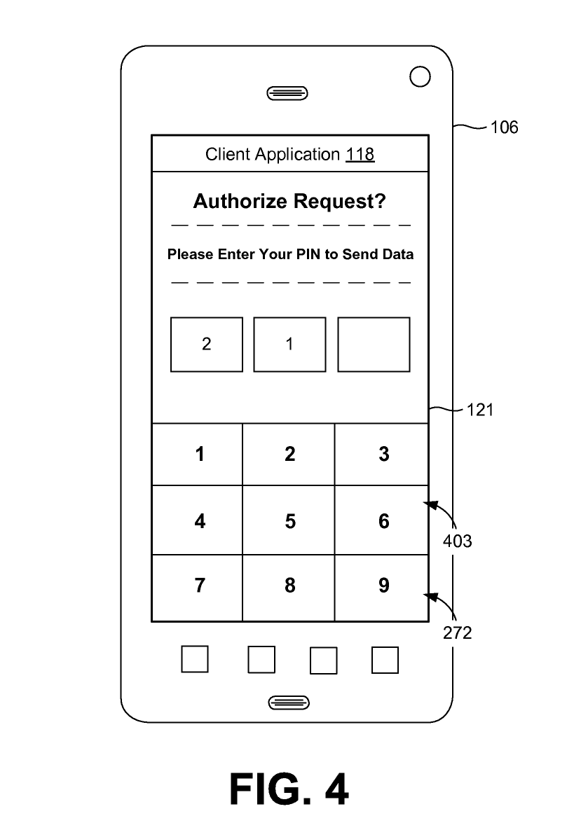

Moving on to FIG. 4, shown is an example of the client device 106 requiring input of a password or a PIN (e.g., authentication data 248) in order to obtain consent from a user of the client device 106 to transmit health information 109 (FIG. 1) to a requesting service 206 (FIG. 2) according to various embodiments of the present disclosure. In the example of FIG. 4, the client application 118 causes a user interface 272 to be rendered on the display 121 of the client device 106. Specifically, in FIG. 4, the user interface 272 comprises a virtual keyboard 403 that enables a user of the client device 106 to provide a password or a PIN. Although the embodiment of FIG. 4 shows the virtual keyboard 403, a physical keyboard, voice recognition, biometric recognition or face recognition are other examples of authentication that may be employed to obtain consent from a user of the client device 106. In the example of FIG. 4, by manipulating (e.g., pressing and releasing) components corresponding to alphanumeric characters on the virtual keyboard 403, the user may provide a PIN or password that, if correct, authorizes the release of the subset of the health information 109.

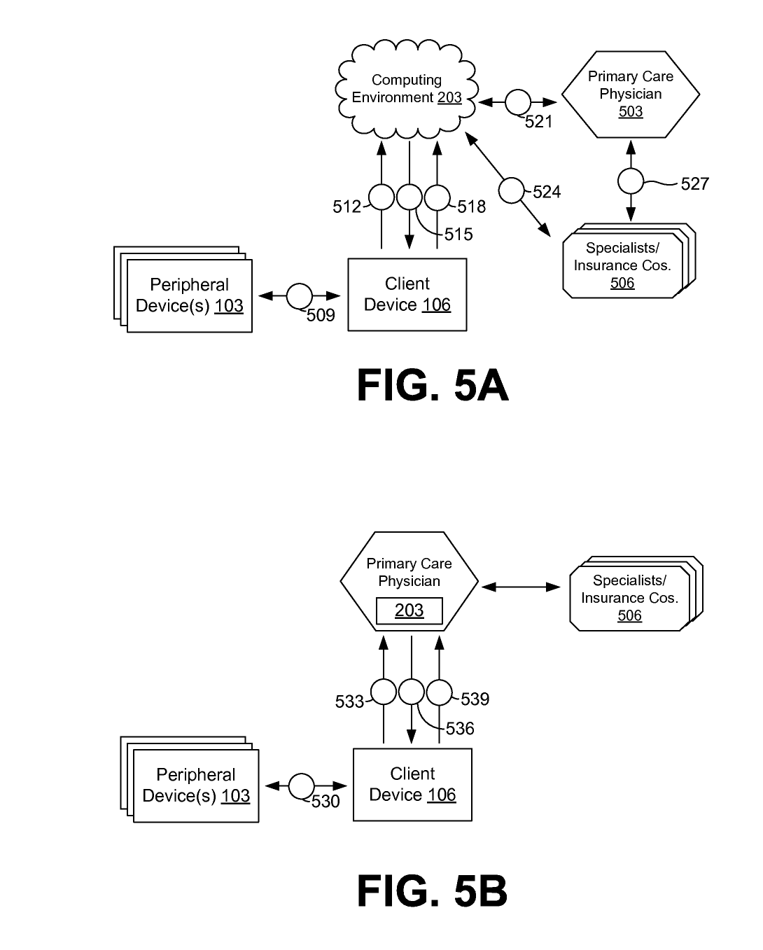

With respect to FIG. 5A, shown is a diagram illustrating a process whereby the client device 106 obtains health information 109 from one or more peripheral devices 103 (e.g., using biometric sensors). As health information 109 is received, the client device 106 may upload or otherwise transmit the health information 109 to the computing environment 203. In various embodiments, the upload or the transmission of the health information 109 to the computing environment 203 does not require consent as the health information 109 will not be released from the computing environment 203 without consent from the user.

If the computing environment 203 receives a request for the health information 109 (e.g., from requesting services 206), the computing environment 203 causes the client application 118 (FIG. 1) executable on the client device 106 to obtain consent from a user of the client device 106. For example, assuming a requesting service 206 were associated with a primary care physician 503, a specialist or an insurance company 506, etc., an electronic service may request health information 109 for a particular user from the computing environment 203. 509, 512, 515, and 518 in FIG. 5A denote an order health information 109 travels along the network 112. 521, 524, and 527 indicate scenarios where user consent may be required when a requesting service 206 requests the health information 109 from the device management service.

For example, a primary care physician 503 may desire to send the health information 109 after it is received to another source, such as a specialist or an insurance company 506, a medical outsourcing company, etc. The requesting service 206 associated with the primary care physician 503 may send a request to the computing environment 203 for authority to transmit the health information 109 to the specialist or the insurance company 506, the medical outsourcing company, etc. To this end, the computing environment 203, may obtain consent from a user of the client device 106 prior to providing the requesting service 206 with authorization to transmit the health information 109 to another source. The user providing consent may include the embodiments described above with respect to FIGS. 3 and 4. For example, the user of the client device 106 may be required to provide a password or a PIN to provide consent to transmit the health information 109 to a downstream source.

Referring next to FIG. 5B, shown is an example of an embodiment where an organization, such as a primary care physician, operates and/or manages the computing environment 203. Similar to the embodiment described above in FIG. 5A, the client device 106 obtains health information 109 from the one or more peripheral devices 103 (e.g., using biometric sensors). The client device 106 may be configured to upload the health information 109 as it is received or at predefined times to the computing environment 203 managed, for example, by the primary care physician 503. Assuming the primary care physician 503 desires to send the health information 109 to another source (e.g., the specialist or the insurance company 506), the primary care physician 503 may request consent from a user of the client device 106 to transmit the health information 109 to an identified party. The user providing consent may include the embodiments described above with respect to FIGS. 3 and 4. For example, the user of the client device 106 may be required to provide a password or a PIN to provide consent to transmit the health information 109 to a downstream source. 530, 533, 536, and 539 in FIG. 5B denote an order health information 109 travels along the network 112.

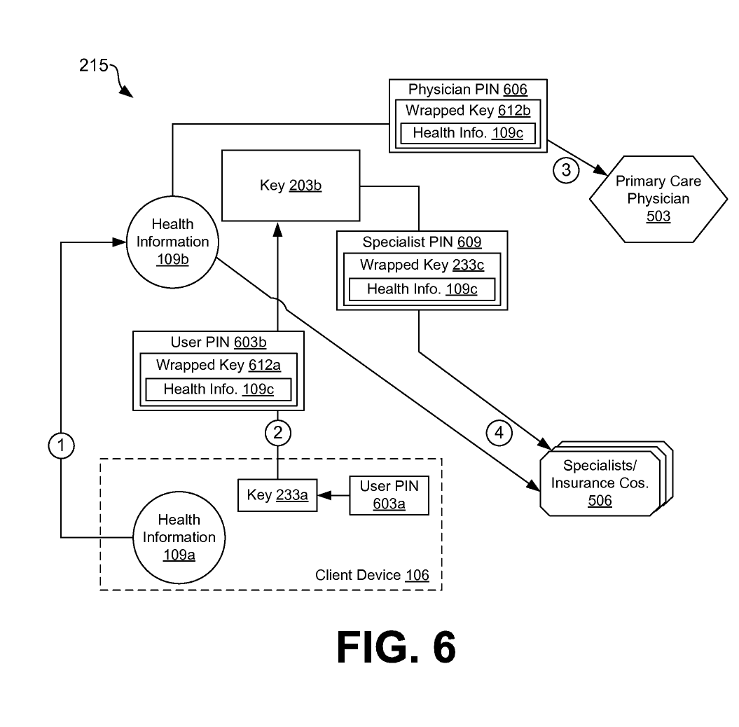

Moving on to FIG. 6, shown is an example of various cryptographic methods that may be performed to encrypt and/or decrypt the health information 109 by employing one or more keys 233 according to various embodiments of the present disclosure. During an enrollment with the management service 215, the user of the client device 106, the requesting services 206 (e.g., primary care providers, specialists, personal trainers, and insurance companies) may set up a specific password or PIN or one may be automatically generated on their behalf. To this end, the management service 215 may store and maintain a plurality of pins (or passwords), where each of the pins is associated with various users of client devices 106 and/or various requesting services 206. For purposes of illustration, the PIN for the user of the client device 106 is referred to as user PIN 603, the PIN for the primary care physician (e.g., a requesting service 206) is referred to as physician PIN 606, and the PIN for the specialist or insurance company is referred to as specialist PIN 609.

As health information 109 is received from the one or more peripheral devices 103 (FIG. 1), the client application 118 (FIG. 1) causes the client device 106 to encrypt the health information 109a with a key 233a using, for example, the advanced encryption standard (AES), Twofish, Serpent, Blowfish, CASTS, RC4, 3DES, Skipjack, Safer+/++, RC3, or another symmetric encryption algorithm. In various embodiments, a password-derived key (e.g., pbkdf2) may be used to generate the key 233. The encrypted health information 109a may be sent directly to the management service 215 over the network 112 (FIG. 1).

However, in various embodiments, prior to sending the health information 109a over the network 112 to the management service 215, the key 233a may be protected with a password or a PIN using, for example, the user PIN 603a. Key wrapping includes performing symmetric encryption to encapsulate or encrypt cryptographic key material. Key wrapping may employ cryptographic block ciphers and cryptographic hash functions. To this end, the user PIN 603 wraps the key 233a to generate a wrapped key 612a. The health information 109c may then be sent to the management service 215.

With the user PIN 603b, the management service 215 is able to access the key 233 by unwrapping the wrapped key 612a using the user PIN 603b to perform decryption of the health information 109 or subsequent encryption of the health information 109, if necessary. In response to a request received from a requesting service 206 (and after obtaining user consent), the management service 215 may send the encrypted health information 109 to a requesting service 206, such as a primary care physician.

In one embodiment, the wrapped key 612a may be unwrapped using at least the user PIN 603b corresponding to the client device 106. Subsequently, the key 233 may be wrapped using a requesting service password (e.g., the physician PIN 606 or the specialist PIN 609) corresponding to the requesting service 206, wherein the requesting service 206 is capable of accessing the key 233b using at least the physician PIN 606 or the specialist PIN 609. In another embodiment, the wrapped key 612a may be wrapped an additional time using a requesting service password (e.g., the physician PIN 606 or the specialist PIN 609) corresponding to the requesting service 206, wherein the requesting service 206 is capable of accessing the key 233b using at least the physician PIN 606 or the specialist PIN 609.

In various embodiments, consent and authentication of the user may also be accomplished using a X.509 Certificate or a similar certificate. Further, in various embodiments, the key 233 may be protected by a public/private key pair issued by the management service 215. Transmission of consent and/or health information 109 can further be protected via secure sockets layer (SSL) and/or transport layer security (TLS) transmission.

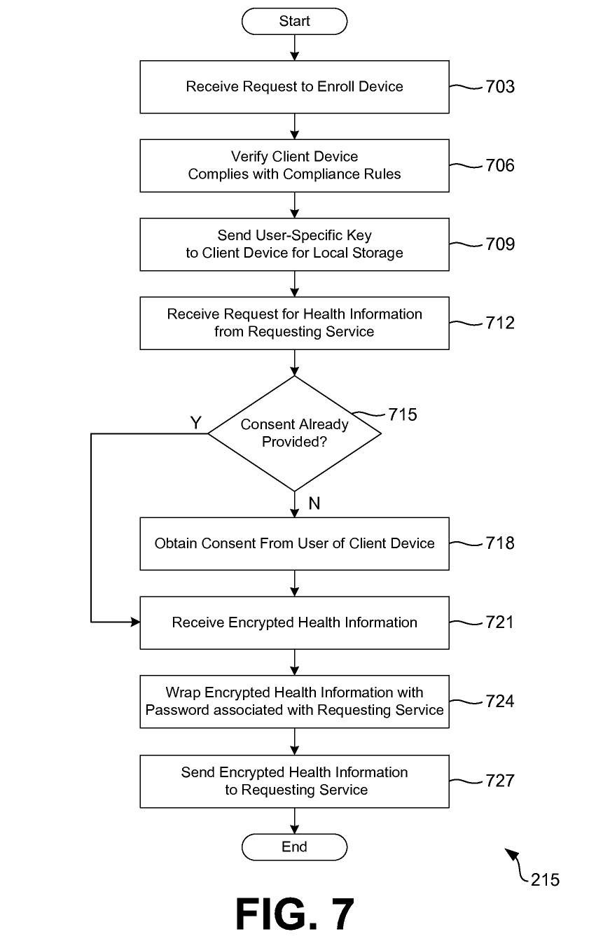

Referring next to FIG. 7, shown is a flowchart that provides one example of the operation of a portion of the management service 215 according to various embodiments. It is understood that the flowchart of FIG. 7 provides merely an example of the many different types of functional arrangements that may be employed to implement the operation of the portion of the management service 215 as described herein. As an alternative, the flowchart of FIG. 7 may be viewed as depicting an example of elements of a method implemented in the computing environment 203 (FIG. 2) according to one or more embodiments.

It is assumed the one or more requesting services 206 (e.g., doctor's offices, hospitals, insurance companies, health information aggregators, etc.) have enrolled and/or registered with the management service 215 such that the requesting service 206 is able to request health information 109 for a particular user. Enrollment and/or registration of a particular one of the requesting services 206 may include vetting and scrutinizing the particular requesting service 206 such that unauthorized access to sensitive information is not obtained. To this end, each requesting service 206 may be assigned a role 242 that defines a level of access to the health information 109 for a particular user and/or client device 106. Although in various embodiments, the role 242 for a particular requesting service 206 may be set by the management service 215 during a registration and/or enrollment process (e.g., based at least in part on a type of requesting service 206), the role 242 may be defined and/or modified by the user associated with the health information 109 being requested.

For example, the user of the client device 106 may set the role 242 for his or her physician such that the requesting service 206 associated with the physician has access to all health information 109 (e.g., nutritional information, heart rate data, physical activity, and blood sugar measurements). Similarly, the same user of the client device 106 may set a different role 242 for his or her personal trainer such that the personal trainer only has access to a subset of the health information 109 (e.g., nutritional information and physical activity).

In various embodiments, when a user of a client device 106 enrolls a particular type of peripheral device 103, the health information 109 obtained by the peripheral device 103 is automatically made accessible to a particular requesting service 206 based at least in part on the role 242 assigned to the particular requesting service 206. For example, assuming the user of the client device 106 enrolled a blood sugar monitor with the management service 215, any health information 109 measured by the blood sugar monitor will automatically be made accessible to the requesting service 206 associated with the user's physician while the user's personal trainer is denied access.

Beginning with 703, the management service 215 receives a request to enroll and/or register a client device 106 (FIG. 1) with the management service 215. Enrolling and/or registering the client device 106 may include a user downloading a particular client application 118 and registering the client device 106 via one or more user interfaces 272 (FIG. 2) rendered in the display 121 (FIG. 1) of the client device 106. In various embodiments, one or more peripheral devices 103 associated with the client device 106 may be registered and/or enrolled with the management service 215.

Moving on to 706, the management service 215 verifies that the client device 106 complies or the peripheral device 103 associated with the client device 106 with one or more compliance rules 230, for example, to ensure that the client device 106 or the peripheral device 103 does not have any security vulnerabilities that may compromise storage of sensitive information, including health information 109. Similarly, verifying that the client device 106 and/or the peripheral device 103 complies with one or more compliance rules 230 may be beneficial in ensuring that the user of the client device 106 is not using faulty, dangerous, and/or unapproved peripheral devices 103. Some security vulnerabilities may include unauthorized applications, malware, viruses, worms, key loggers, bots, or other malicious code or software, such as those defined in the blacklist 236. Unauthorized applications may include applications that are not configured to enforce particular configurations and/or compliance rules 230 that reflect the security policies of a regulation, an enterprise, a healthcare provider, etc.

In various embodiments, compliance rules 230 may include restraints on various types of peripheral devices 103 and may be defined by the requesting service 206. For example, a physician may desire that his or her patient only use a particular brand of a heart rate monitor. Further, compliance rules 230 may include requiring a user to provide consent one or more times prior to sending particular health information 109 and/or a particular type of health information 109.

In some embodiments, the management service 215 may instruct the client device 106 to present a notification to the user of the client device 106. For instance, the client device 106 may present a notification to the user of the client device 106 that specifies that the client device 106 is not in a state of compliance with a particular compliance rule 230 (i.e., such that the user may make alterations to the client device 106 to place the client device 106 in a state of compliance with the compliance rule 230). The client device 106 may also present a notification that specifies that if the client device 106 is not placed in a state of compliance with the particular compliance rule 230 (e.g., by enabling, disabling, and/or modifying the client device 106) before a threshold duration expires, that a particular remedial action may be taken on the client device 106 (e.g., erasing data from the client device 106, preventing the client device 106 from accessing particular files or resources, and/or locking particular functionality of the client device 106).

Assuming the client device 106 complies with one or more compliance rules 230, in 709, a key 233 may be generated and/or sent to the client device 106. In various embodiments, the key 233 may be a user-specific key 233 generated based at least in part on a password, a pin, or other information provided by the user. To this end, the user may use the password, the pin, or other information to unlock and gain access to particular data. The key 233 provided by the management service 215 to the client device 106 may be stored locally on the client device 106 (e.g., in memory internal to the client device 106).

As discussed above, requests for health information 109 may be received from various requesting services 206. For example, a physician may desire to see recent blood sugar measurements for a particular patient. The physician, acting as a requesting service 206 through the management service 215, may request the blood sugar measurements from the client device 106 associated with the particular patient. In response to a request for health information 109, the process proceeds to 715 where it is determined whether consent has already been provided for the type of information being requested (e.g., blood sugar measurements) and/or the requesting service 206 (e.g., the particular patient's physician). If consent from the user of the client device 106 (e.g., the patient) has already been provided, the process proceeds to 721. However, if consent from the user of the client device 106 has not been provided, the process proceeds to 718 where consent is obtained from a user of the client device 106.

Obtaining consent from a user of the client device 106 may include, for example, causing a notification to be presented to the user of the client device 106 associated with the request for health information 109. In various embodiments, the notification may include the requesting service 206, the type of information being requested, the specific health information 109 being requested, etc. Accordingly, the user may be provided with sufficient information to provide informed consent in distributing his or her health information 109. Assuming consent to access the health information 109 has been provided in association with the request, in 721, the management service 215 may receive health information 109 from the client device 106 prior to the health information 109 being sent to the requesting service 206.

In various embodiments, the client device 106, through the client application 118, is configured to encrypt the health information 109 prior to storage on the client device 106 or transmission of the network 112. Encryption may include utilizing the key 233 provided to the client device 106, for example, upon a registration or an enrollment of the client device 106 with the management service 215. Accordingly, the health information 109 received by the management service 215 in the computing environment 203 may be encrypted using the key 233. This is beneficial as the health information 109 is encrypted while it is sent over the network 112, making it difficult for packet sniffing applications or other malicious software to identify the health information 109 and/or the source of the health information 109. As the health information 109 is encrypted using the key 233 (e.g., unique to the user and/or the client device 106), it remains difficult or impossible for the health information 109 to be decrypted by third parties.

In 724, the health information 109 as encrypted is wrapped by the management service 215 through the data encryption service 218 or a similar service. However, in various embodiments, encrypting the health information 109 includes decrypting the health information 109 (e.g., using the key 233 accessible to the management service 215 or the user PIN 603 (FIG. 6)) prior to encryption by the computing environment 203. After decrypting the health information 109, encryption of the health information 109 may be performed based on, for example, a key 233 and/or a password associated with the requesting service 206 (e.g., the physician PIN 606 (FIG. 6) or the specialist PIN 609 (FIG. 6)).

In some embodiments, the encrypted health information 109 as wrapped by the client device 106 using the user PIN 603 may be further wrapped, i.e., without first decrypting the health information 109. To this end, the health information 109 goes through two layers of encryption, further increasing difficulty of unauthorized decryption and/or access to the health information 109. The second encryption process, performed by the management service 215, may utilize a service-specific password (e.g., the physician PIN 606 or the specialist PIN 609). As the requesting service 206 is provided with a key 233 specific to the requesting service 206, for example, upon a registration or enrollment with the management service 215, the requesting service 206 is capable of decrypting the health information 109 using the key 233 and/or a password associated with the requesting service 206.

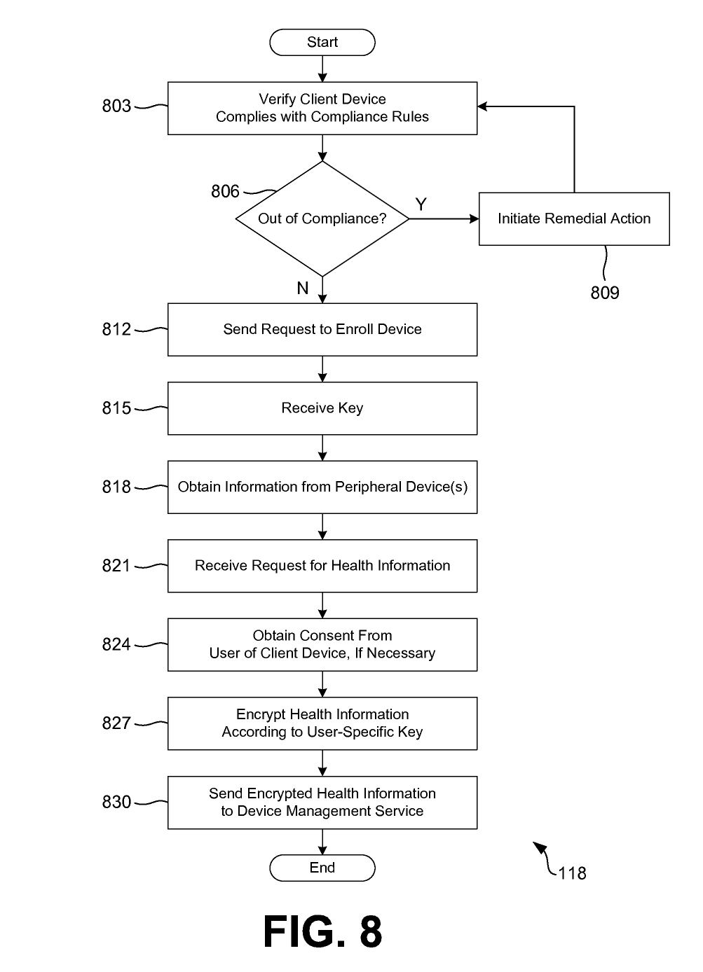

Moving on to FIG. 8, shown is a flowchart that provides one example of the operation of a portion of the client application 118 according to various embodiments. It is understood that the flowchart of FIG. 8 provides merely an example of the many different types of functional arrangements that may be employed to implement the operation of the portion of the client application 118 as described herein. As an alternative, the flowchart of FIG. 8 may be viewed as depicting an example of elements of a method implemented in the client device 106 (FIG. 1) according to one or more embodiments.

Starting with 803, the client application 118 verifies that the client device 106 complies with one or more compliance rules 230 (FIG. 2), for example, to ensure that the client device 106 does not have any security vulnerabilities that may compromise storage of sensitive information, including health information 109. Similarly, verifying that the client device 106 complies with one or more compliance rules 230 is beneficial to ensure that the user of the client device 106 is not using faulty, dangerous, and/or unapproved peripheral devices 103. Some security vulnerabilities may include unauthorized applications, malware, viruses, worms, key loggers, bots, or other malicious code or software, such as those defined in the blacklist 236 (FIG. 2). Unauthorized applications may include applications that are not configured to enforce particular configurations and/or compliance rules 230 that reflect the security policies of a regulation, an enterprise, a healthcare provider, etc.

Conversely, examples of applications that may be considered authorized include applications that provide the ability to enforce particular configurations and/or particular compliance rules 230, such as those defined in the whitelist 239 (FIG. 2). For example, in the context of a statute or a regulatory requirement, authorized applications may include applications modified and/or configured to enforce particular configurations and/or compliance rules 230 that reflect the security policies of the statute or the regulatory requirement.

Accordingly, compliance rules 230 may comprise particular configurations or particular constraints that must be satisfied prior to storing and/or transmitting health information 109 by the client device 106. In various embodiments, compliance rules 230 may include restraints on various types of peripheral devices 103 and may be defined by the requesting service 206. For example, a physician may desire that his or her patient only use a particular brand of a heart rate monitor. Further, compliance rules 230 may include requiring a user to provide consent one or more times prior to sending particular health information 109 and/or a particular type of health information 109.

Next, in 806, it is determined whether the client device 106 is out of compliance as described in detail above. If the client device 106 is out of compliance, in 809, a remedial action may be initiated by the client application 118.

In some embodiments, a remedial action may include presenting a notification to the user of the client device 106 in the display 121 (FIG. 1). For instance, the client device 106 may present a notification to the user of the client device 106 that specifies that the client device 106 is not in a state of compliance with a particular compliance rule 230 (i.e., such that the user may make alterations to the client device 106 to place the client device 106 in a state of compliance with the compliance rule 230). The client device 106 may also present a notification that specifies that if the client device 106 is not placed in a state of compliance with the particular compliance rule 230 (e.g., by enabling, disabling, and/or modifying the client device 106) before a threshold duration expires, that a particular remedial action may be taken on the client device 106 (e.g., erasing data from the client device 106, preventing the client device 106 from accessing particular files or resources, and/or locking particular functionality of the client device 106).

Assuming the client device 106 complies with one or more compliance rules 230, in 812, a request may be sent from the client device 106 to the management service 215 (FIG. 2) to enroll and/or register the client device 106 with the management service 215. In addition, the process described in 812 may include enrolling and/or registering one or more peripheral devices 103 with the management service 215.

As discussed above with respect to FIG. 7, a key 233 may be generated by the management service 215 and sent to the client device 106. In 815, assuming the client device 106 and/or the one or more peripheral devices 103 are successfully enrolled with the management service 215, the key 233 may be received by the client device 106. In various embodiments, the key 233 may be a user-specific key 233 generated based at least in part on a password, a pin, or other information provided by the user prior to enrolling the client device 106 with the management service 215. To this end, the user may use the password, the pin, or other information to unlock and gain access to particular data. The key 233 received by the client device 106 may be stored locally on the client device 106 (e.g., in memory internal to the client device 106).

Next, in 818, health information 109 may be obtained from one or more peripheral devices 103. Although described in context of the peripheral devices 103, health information 109 is not limited to data collected from the peripheral devices 103. For example, health information 109 may include information manually entered into the client device 106 by the user such as nutritional information, blood sugar measurements, pharmaceutical prescriptions, workout regiments, etc. Moreover, although shown in a particular location in the flowchart of FIG. 8, the client application 118 may obtain the health information 109 from the user or from the peripheral devices 103 are various times during its execution.

As discussed above, requests for health information 109 may be received from various requesting services 206. For example, a physician may desire to see recent blood sugar measurements for a particular patient. The physician, acting as a requesting service 206 through the management service 215, may request the blood sugar measurements from the client device 106 associated with the particular patient. In 821, a request is received from the management service 215 (or from the requesting service 206 directly). In 824, consent may be obtained from a user of the client device 106 for the health information 109 identified in the request, if necessary. For example, it may be determined whether consent has already been provided for the type of information being requested (e.g., blood sugar measurements) and/or the requesting service 206 (e.g., the particular patient's physician). Obtaining consent from a user of the client device 106 may include, for example, causing a notification to be presented to the user of the client device 106 associated with the request for health information 109. In various embodiments, the notification may include the requesting service 206, the type of information being requested, the specific health information 109 being requested, etc. Accordingly, the user may be provided with sufficient information to provide informed consent in distributing his or her health information 109. However, if consent from the user of the client device 106 (e.g., the patient) has already been provided, the process may proceed to 827.

Next, in 827, the health information 109 may be encrypted according to the key 233 received in 815, such as a user-specific key 233 generated using a password or a PIN provided by the user during enrollment. In various embodiments, this may not be needed if the health information 109 is encrypted as it is stored in memory local to the client device 106. Assuming the health information 109 has not been encrypted, the health information 109 is encrypted prior to sending to the management service 215, as shown in 830.

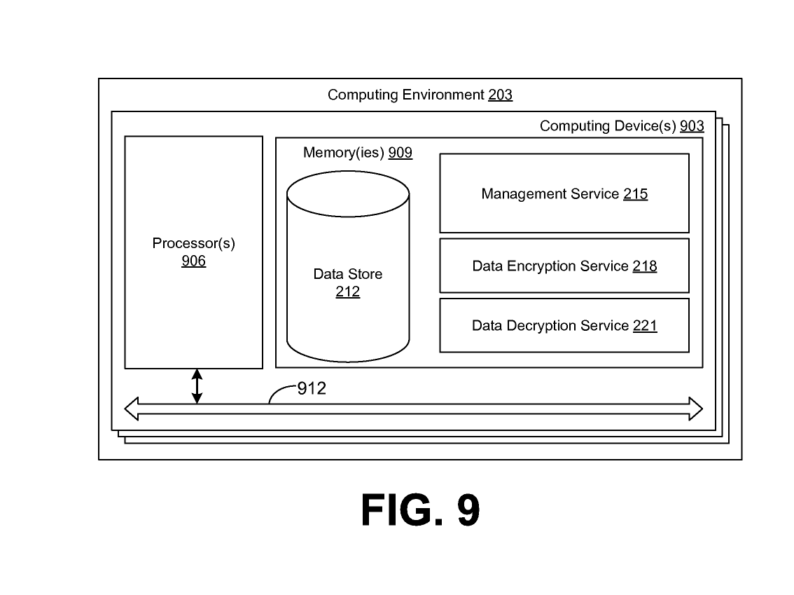

With reference to FIG. 9, shown is a schematic block diagram of the computing environment 203 according to an embodiment of the present disclosure. The computing environment 203 includes one or more computing devices 903. Each computing device 903 includes at least one processor circuit, for example, having a processor 906 and a memory 909, both of which are coupled to a local interface 912. To this end, each computing device 903 may comprise, for example, at least one server computer or like device. The local interface 912 may comprise, for example, a data bus with an accompanying address/control bus or other bus structure as can be appreciated.

Stored in the memory 909 are both data and several components that are executable by the processor 906. In particular, stored in the memory 909 and executable by the processor 906 are the management service 215, the data encryption service 218, the data decryption service 221, the communication interface 224, and potentially other applications. Also stored in the memory 909 may be a data store 212 and other data. In addition, an operating system may be stored in the memory 909 and executable by the processor 906.

It is understood that there may be other applications that are stored in the memory 909 and are executable by the processor 906 as can be appreciated. Where any component discussed herein is implemented in the form of software, any one of a number of programming languages may be employed such as, for example, C, C++, C#, Objective C, Java®, JavaScript®, Perl, PHP, Visual Basic®, Python®, Ruby, Flash®, or other programming languages.

A number of software components are stored in the memory 909 and are executable by the processor 906. In this respect, the term “executable” means a program file that is in a form that can ultimately be run by the processor 906. Examples of executable programs may be, for example, a compiled program that can be translated into machine code in a format that can be loaded into a random access portion of the memory 909 and run by the processor 906, source code that may be expressed in proper format such as object code that is capable of being loaded into a random access portion of the memory 909 and executed by the processor 906, or source code that may be interpreted by another executable program to generate instructions in a random access portion of the memory 909 to be executed by the processor 906, etc. An executable program may be stored in any portion or component of the memory 909. The memory 909 is defined herein as including both volatile and nonvolatile memory and data storage components.

Also, the processor 906 may represent multiple processors 906 and/or multiple processor cores and the memory 909 may represent multiple memories 909 that operate in parallel processing circuits, respectively. In such a case, the local interface 912 may be an appropriate network that facilitates communication between any two of the multiple processors 906, between any processor 906 and any of the memories 909, or between any two of the memories 909, etc. The local interface 912 may comprise additional systems designed to coordinate this communication, including, for example, performing load balancing. The processor 906 may be of electrical or of some other available construction.

Although the management service 215, the data encryption service 218, the data decryption service 221, and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts of FIGS. 7 and 8 show the functionality and operation of an implementation of portions of the management service 215 and the client application 118, respectively, and potentially portions of the encryption service 218, the description service 221, and/or the communication interface 224. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 906 in a computer system or other system. The machine code may be converted from the source code, etc. If embodied in hardware, each block may represent a circuit or a number of interconnected circuits to implement the specified logical function(s).

Although the flowcharts of FIGS. 7 and 8 show a specific order of execution, it is understood that the order of execution may differ from that which is depicted. For example, the order of execution of two or more blocks may be scrambled relative to the order shown. Also, two or more blocks shown in succession in FIGS. 7 and 8 may be executed concurrently or with partial concurrence. Further, in some embodiments, one or more of the blocks shown in FIG. 5 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the management service 215, the data encryption service 218, the data decryption service 221, and/or the communication interface 224, that comprises software or code can be embodied in any non-transitory computer-readable medium for use by or in connection with an instruction execution system such as, for example, a processor 906 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any logic or application described herein, including the management service 215, the data encryption service 218, the data decryption service 221, and the communication interface 224, may be implemented and structured in a variety of ways. For example, one or more applications described may be implemented as modules or components of a single application. Further, one or more applications described herein may be executed in shared or separate computing devices or a combination thereof. For example, a plurality of the applications described herein may execute in the same computing device 903, or in multiple computing devices in the same computing environment 203. Additionally, it is understood that terms such as “application,” “service,” “system,” “engine,” “module,” and so on may be interchangeable and are not intended to be limiting.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A system, comprising:
at least one computing device;
program code that, when executed by the at least one computing device, causes the at least one computing device to at least:
receive a request from a requesting service for a transmission of health information generated by at least one of a client device or a peripheral device associated with the client device;
determine whether at least one compliance rule is satisfied by at least one of the client device or the peripheral device associated with the client device;
determine whether consent for the transmission of the health information generated by at least one of the client device or the peripheral device associated with the client device to the requesting service has been provided by a user of the client device, wherein the consent comprises a user input to the client device indicating that the user consents to the transmission of the health information generated by at least one of the client device or the peripheral device associated with the client device to the requesting service; and
in response to a determination that the at least one compliance rule is satisfied and that consent has been provided by the user of the client device, causing the health information to be transmitted to the requesting service.

2. The system of claim 1, further comprising program code that causes the at least one computing device to at least receive a user password corresponding to the client device, wherein the user password is used to encrypt a cryptographic key prior to the transmission of the health information from the client device to the at least one computing device.

3. The system of claim 2, further comprising program code that causes the at least one computing device to at least:
decrypt the cryptographic key using at least the user password corresponding to the client device; and
encrypt the cryptographic key using a requesting service password corresponding to the requesting service, wherein the requesting service is capable of accessing the cryptographic key using at least the requesting service password.

4. The system of claim 2, further comprising program code that causes the at least one computing device to at least encrypt the cryptographic key, as encrypted with the user password, using a requesting service password corresponding to the requesting service, wherein the requesting service is capable of accessing the cryptographic key using at least the requesting service password and the user password.

5. The system of claim 1, further comprising program code that causes the at least one computing device to at least, in response to consent not being providing by the user of the client device, obtain consent from the user by causing a display of a user interface in a display of the client device that prompts the user of the client device to provide a password.

6. The system of claim 1, wherein the consent being providing by the user of the client device is obtained automatically based at least in part on a role associated with the requesting service and access predefined by the user in association with the role.

7. The system of claim 1, wherein the peripheral device comprises at least one biometric sensor.

8. A non-transitory computer-readable medium embodying a program executable in at least one computing device, comprising code that:
enrolls a client device or a peripheral device associated with the client device responsive to the client device or the peripheral device complying with at least one compliance rule;
accesses health information received from the client device or the peripheral device as registered in response to a request received from a requesting service for the health information, wherein the health information as received is encrypted according to a cryptographic key;
determines whether consent to send the health information to the requesting service has been provided by a user of the client device; and
in response to the consent being providing by the user of the client device, cause a transmission of the health information as encrypted to the requesting service.

9. The non-transitory computer-readable medium of claim 8, wherein the program further comprises code that receives a user password corresponding to the client device, wherein the user password is used to encrypt the cryptographic key during transmission from the client device to the at least one computing device.

10. The non-transitory computer-readable medium of claim 9, wherein the program further comprises code that:
decrypts the cryptographic key using at least the user password corresponding to the client device; and
encrypts the cryptographic key using a requesting service password corresponding to the requesting service, wherein the requesting service is capable of accessing the cryptographic key using at least the requesting service password.

11. The non-transitory computer-readable medium of claim 9, wherein the program further comprises code that encrypts the cryptographic key, as encrypted with the user password, using a requesting service password corresponding to the requesting service, wherein the requesting service is capable of accessing the cryptographic key using at least the requesting service password and the user password.

12. The non-transitory computer-readable medium of claim 8, wherein the program further comprises code that, in response to consent not being providing by the user of the client device, obtains consent from the user by causing a display of a user interface in a display of the client device that prompts the user of the client device to provide a password.

13. The non-transitory computer-readable medium of claim 8, wherein the consent being providing by the user of the client device is obtained automatically based at least in part on a role associated with the requesting service and access predefined by the user in association with the role.

14. The non-transitory computer-readable medium of claim 8, wherein the peripheral device comprises at least one biometric sensor.

15. A system, comprising:
a computing device;
program code that, when executed by the computing device, causes the computing device to at least:
recognize, at the computing device, a state in which health information is conditionally transmitted to a requesting service, wherein the health information is specific to at least one person who is a user of a client device or a peripheral device from which the health information is acquired;
verify, at the computing device, that at least one condition for a transmission of the health information is satisfied, including:
determining that at least one compliance rule for transmitting the health information is satisfied; and
determining whether consent for the particular transmitting of the health information to the requesting service has been provided, where determining that consent has been provided is based on a communication between the computing device and the client device or peripheral device; and
in response to verifying that the at least one condition is satisfied, transmit, at the computing device, the health information to the requesting service.

16. The system of claim 15, further comprising program code that causes the at least one computing device to receive, at the computing device, a user password corresponding to the client device, wherein the user password is used to encrypt a cryptographic key used to encrypt the health information prior to the transmission.

17. The system of claim 16, further comprising program code that causes the at least one computing device to:
decrypt, at the computing device, the cryptographic key using at least the user password corresponding to the client device; and
encrypt, at the computing device, the cryptographic key using a requesting service password corresponding to the requesting service, wherein the requesting service is capable of accessing the cryptographic key using at least the requesting service password.

18. The system of claim 15, wherein determining that the at least one compliance rule for transmitting the health information is satisfied further comprising determining whether the client device or the peripheral device associated with the client device complies with a predefined statutory constraint or a regulatory constraint.

19. The system of claim 15, further comprising, in response to consent not being providing by the user of the client device, obtaining, by the at least one computing device, the consent from the user by causing a display of a user interface in a display of the client device that prompts the user of the client device to provide a password.

20. The system of claim 15, wherein the consent being provided by the user of the client device is obtained automatically based at least in part on a role associated with the requesting service and access predefined by the user in association with the role.
